(19) United States
(12) Patent Application Publication
(10) Pub. No.: US 2008/0275937 A1
(43) Pub. Date: Nov. 6, 2008

(54) Control Device, Method and Program for Providing Information

(76) Inventor: Kenya NISHIKI, Chigasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/108,587

(22) Filed: Apr. 24, 2008

(30) Foreign Application Priority Data
Apr. 26, 2007 (JP) 2007-117235

(51) Int. Cl. G06F 15/16

(52) U.S. Cl. 709/202

(57) ABSTRACT

A technology is provided to facilitate provision of information to a plurality of clients in a computer telephony integrated system. Plural user terminals are respectively connected to an information-providing server that provides requested information, a session control server, and a portal server. Sessions are established between each of the above devices. Upon receiving a data request from any one of the user terminals, the portal server sends the data request to the session control server. The session control server sends the data request to the information providing server. The information providing server sends the requested data to the session control server. The session control server sends the data to the portal server. The portal server sends the data to the respective user terminals.

### INCORPORATION BY REFERENCE

This application claims priority based on a Japanese patent application, No. 2007-117235 filed on Apr. 26, 2007, the entire contents of which are incorporated herein by reference.

### BACKGROUND OF THE INVENTION

The present invention relates to technology that provides a plurality of independent services in a cooperated and synthesized way, the services being provided in a distributed manner over an IP network.

For next-generation networks, construction has begun of systems that integrate speech and video application server functions based on SIP (Session Initiation Protocol), and then provide applications capable of cooperating in real-time to a plurality of users in a Web application environment.

Application cooperating technology is described in JP-A-2005-158037 (Patent Document 1). Patent Document 1 describes a technology that integrates SIP-AP server functions based on SIP in a Web (World Wide Web)-AP server environment.

### SUMMARY OF THE INVENTION

However, the technology described in Patent Document 1 only calls another application from a specific application. Consequently, for example, when users communicating by telephone conduct searches in parallel and both users want to view the results simultaneously, it is necessary for each user to give commands to obtain the same information.

The present invention, being devised in consideration of these circumstances, provides a technology that enables easy multi-session integrated communication. In the present invention, when users want to communicate using independent services in parallel that have differing communication methods, such as WWW, VoIP, and the like, the users do not have to explicitly give commands specifying the method for calling a service or the methods for conversion/reference performed on the data obtained thereby.

The present invention is a control device that respectively connects a plurality of user terminals to a plurality of information providing devices that provide requested information. The control device comprises: a request receiving unit that receives a data request from any one of the user terminals when the user terminals establish a session and communication is being conducted, a request relay unit that sends the data request to any one of the information providing devices, and a providing unit that provides information sent from the information providing devices to each of the user terminals such that the session is maintained and the data is provided in a suitable format.

As a result of the present invention, a multi-user, real-time communications system is realized wherein it is possible to conceal differences in the communication methods for speech, video, and data, and wherein external services are linked and integrated, and wherein it becomes easy to share and utilize contents.

These and other benefits are described throughout the present specification. A further understanding of the nature and advantages of the invention may be realized by reference to the remaining portions of the specification and the attached drawings.

### BRIEF DESCRIPTION OF THE DRAWINGS BRIEF DESCRIPTION OF THE DRAWINGS

FIG. 1 shows an exemplary system configuration of a first embodiment;

FIG. 2 shows an exemplary hardware configuration of the first embodiment;

FIG. 3 shows an example of functional blocks of the first embodiment;

FIG. 4 shows an example of a session management table of the first embodiment;

FIG. 5 shows an example of a user management table of the first embodiment;

FIG. 6 shows an exemplary sequence of the first embodiment;

FIG. 7 shows an exemplary sequence of the first embodiment;

FIG. 8 shows an exemplary screen layout of the first embodiment;

FIG. 9 shows an exemplary sequence of the first embodiment;

FIG. 10 shows an exemplary screen layout of the first embodiment;

FIG. 11 shows exemplary operation of a session control server of the first embodiment;

FIG. 12 shows exemplary operation of the session control server of the first embodiment;

FIG. 13 shows an example of VXML of the first embodiment; and

FIG. 14 shows an exemplary system configuration of a second embodiment.

### DETAILED DESCRIPTION OF THE EMBODIMENTS

Hereinafter, an embodiment of the present invention will be described in detail with reference to the drawings.

### First Embodiment

A first embodiment will now be described.

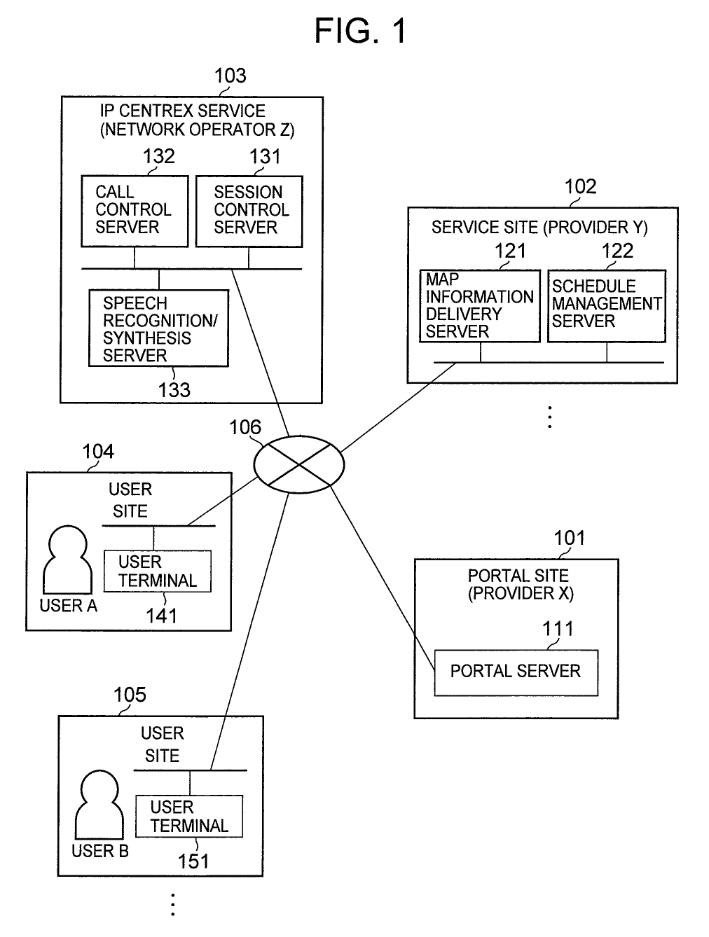

An exemplary system configuration of the first embodiment will now be described with reference to FIG. 1.

FIG. 1 shows the first embodiment which has a portal site 101, a service site 102, an IP Centrex service 103, and a user site 104, a user site 105, and the like. At the portal site 101, a portal server 111 is installed. At the service site 102, a map information delivery server 121, a schedule management server 122, and the like, are installed. At the IP Centrex service 103, a session control server 131, a call control server 132, a speech recognition/synthesis server 133, are installed. There is a user terminal 141 at the user site 104. There is a user terminal 151 at the user site 105. The portal server 111, the map information delivery server 121, the schedule management server 122, the session control server 131, the call control server 132, the speech recognition/synthesis server 133, the user terminal 141, and the user terminal 151 are respectively connected via a communications network 106.

The user terminal 141 and the user terminal 151 are respective information terminals having communication functions, such as a PC (personal computer). The user terminal 141 and the user terminal 151 respectively send data requests according to respective commands given by a user A and a user B, and output the data sent in response to the request. In addition, the user terminal 141 and the user terminal 151 realize IP telephony functions using VoIP (Voice over Internet Protocol). The user A and the user B respectively make telephone calls by using an input/output device (not shown in the drawings) connected to the user terminal 141 and the user terminal 151. The user terminal 141 and user terminal 151 are to the same as those of the conventional art.

The map information delivery server 121 and the schedule management server 122 respectively provide data to users. The data provided to users is not particularly limited, but herein, the map information delivery server 121 is taken to provide map information, and the schedule management server 122 is taken to provide individual user schedule information. These map information delivery server 121 and schedule management server 122 are the same as in the conventional art.

The portal server 111 provides portal services to the user A and the user B, respectively. Herein, portal services refer to providing a plurality of types of data through a single interface. In the present embodiment, these data are taken to be obtained from the map information delivery server 121 and the schedule management server 122.

Using connecting information, the call control server 132 initiates calls and the like using conventionally-known SIP (Session Initiation Protocol) technology or the like, thereby establishing a telephony connection. This call control server 132 is the same as in the conventional art. The speech recognition/synthesis server 133 obtains speech data by synthesizing speech from text data. In addition, the speech recognition/synthesis server 133 obtains text data by recognizing speech in speech data. The speech synthesis and speech recognition technologies used by this speech recognition/synthesis server 133 are conventional technologies and not particularly limited. For example, the technologies may be realized using a speech synthesis engine and the like. The session control server 131 controls the provision of data obtained from the map information delivery server 121 and the schedule management server 122 to the portal server 111, as well as the provision of speech data obtained from the speech recognition/synthesis server 133 to the user terminal 141 and the user terminal 151.

The communications network 106 is a carrier IP network, the Internet, or a public network, for example.

As a result of the session control server 131 controlling the provision of data to the user terminal 141 and the user terminal 151, in the present embodiment it becomes possible to provide data obtained from the map information delivery server 121 and the schedule management server 122 to the user terminal 141 and the user terminal 151, respectively. In addition, it becomes possible for the session control server 131 to use the schedule text data obtained from the schedule management server 122 and create speech data via the speech synthesis technology of the speech recognition/synthesis server 133, and then provide this speech data to the user terminal 141 and the user terminal 151, respectively.

It should be appreciated that the number of devices constituting the above-described system is not limited to that shown in FIG. 1, and may be arbitrary. For example, the number of servers that provide information to users is not limited to two, and may be arbitrary. As another example, the number of information terminals used by users is not limited to two, and may be arbitrary.

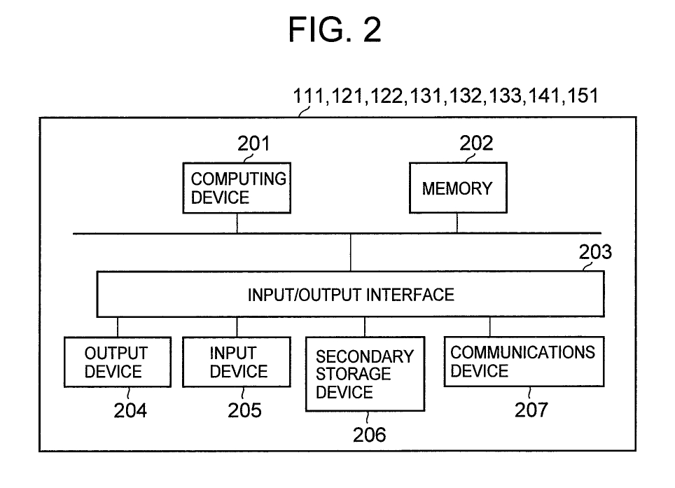

Next, exemplary hardware configurations of each of the above-described devices will be described with reference to FIG. 2.

In FIG. 2, the portal server 111, the map information delivery server 121, the schedule management server 122, the session control server 131, the call control server 132, the speech recognition/synthesis server 133, the user terminal 141, and the user terminal 151 respectively include a computing device 201, memory 202, an input/output interface 203, an output device 204, an input device 205, a secondary storage device 206, and a communications device 207.

The computing device 201 is a CPU (Central Processing Unit), for example. The output device 204 may include for example a display device, speaker, or printer. The input device 205 may include a keyboard, mouse, or scanner. The secondary storage device 206 is for example recording media, such as a CD (Compact Disc) or DVD (Digital Versatile Disc), and a drive for the recording media, such as a HDD (Hard Disk Drive), or a silicon disk.

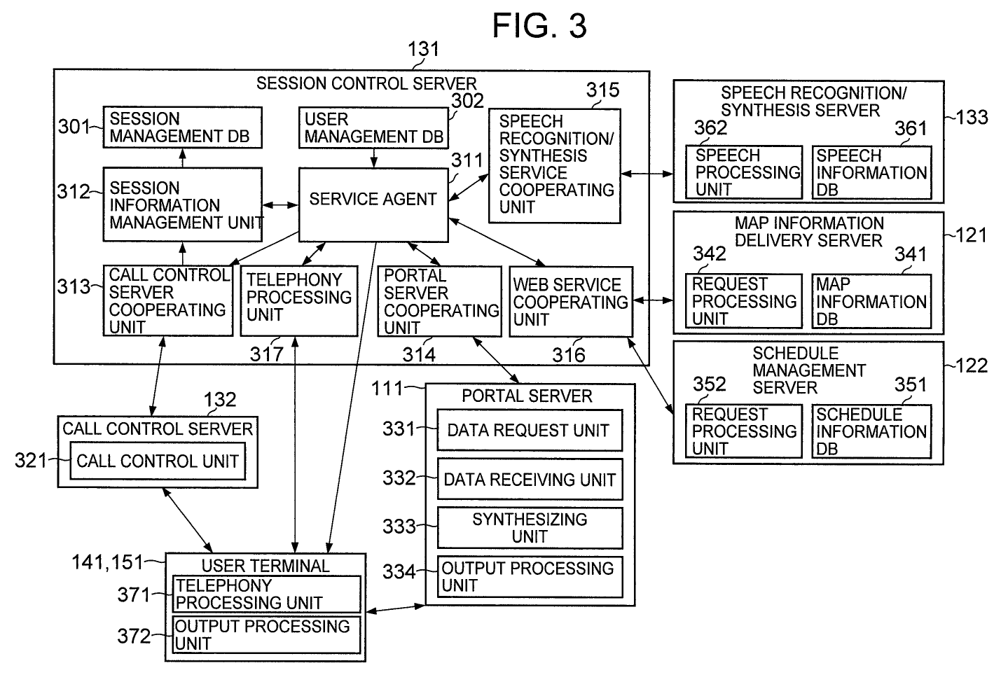

Next, exemplary functional blocks for each of the above-described devices will be described with reference to FIG. 3.

In FIG. 3, the session control server 131 includes a session management DB 301, a user management DB 302, a service agent 311, a session information management unit 312, a call control server cooperating unit 313, a portal server cooperating unit 314, a speech recognition/synthesis service cooperating unit 315, a Web service cooperating unit 316, and a telephony processing unit 317. The secondary storage device 206 of the session control server 131 includes the session management DB 301 and the user management DB 302. In addition, by executing programs (not shown in the drawings) loaded into the memory 202, the computing device 201 of the session control server 131 performs functions of the service agent 311, the session information management unit 312, the call control server cooperating unit 313, the portal server cooperating unit 314, the speech recognition/synthesis service cooperating unit 315, the Web service cooperating unit 316, and the telephony processing unit 317.

The session management DB 301 includes a table for managing information for each session. The user management DB 302 includes a table for managing information for each user for connecting to the portal server 111, the map information delivery server 121, the schedule management server 122, and the call control server 132. The respective tables of the session management DB 301 and the user management DB 302 will be described in detail later.

The service agent 311 controls the session information management unit 312, the call control server cooperating unit 313, the portal server cooperating unit 314, the speech recognition/synthesis service cooperating unit 315, the Web service cooperating unit 316, and the telephony processing unit 317. The session information management unit 312 stores session-related information in a table inside the session management DB 301. The call control server cooperating unit 313 issues call control commands to the call control server 132. The portal server cooperating unit 314 issues commands to the portal server 111, and in addition, receives information output from the portal server 111. The speech recognition/synthesis service cooperating unit 315 supports VXML (VoiceXML), issues speech synthesis commands to the speech recognition/synthesis server 133, and receives speech data sent from the speech recognition/synthesis server 133. In addition, the speech recognition/synthesis service cooperating unit 315 issues speech recognition commands to the speech recognition/synthesis server 133, and receives text data sent from the speech recognition/synthesis server 133. The Web service cooperating unit 316 issues data requests to the map information delivery server 121 and the schedule management server 122, respectively, and receives data sent from the map information delivery server 121 and the schedule management server 122, respectively. The telephony processing unit 317 respectively processes telephony between the user terminal 141 and the user terminal 151. This telephony processing unit 317 processes speech-based telephony using for example the conventionally known RTP (Real-time Transport Protocol) or RTCP (RTP Control Protocol) protocols.

The call control server 132 includes a call control unit 321. By executing programs (not shown in the drawings) loaded into the memory 202, the computing device 201 of the call control server 132 performs the functions of the call control unit 321.

The call control unit 321 controls calls using SIP or a similar protocol. The functions of this call control unit 321 are the same as those of the conventional art.

The speech recognition/synthesis server 133 includes a speech information DB 361 and a speech processing unit 362. The secondary storage device 206 of the speech recognition/synthesis server 133 contains the speech information DB 361. In addition, by executing programs (not shown in the drawings) loaded into the memory 202, the computing device 201 of the speech recognition/synthesis server 133 performs the functions of the speech processing unit 362.

The speech information DB 361 stores speech information. This speech information is not particularly limited; for example, speech data and text data of that speech data may be associated with each other and stored. When the speech processing unit 362 receives a speech recognition request, including speech data, from the session control server 131, the speech processing unit 362 selects from the speech information DB 361 the speech data that matches the received speech data, extracts the text data corresponding to the selected speech data, and then sends this data to the session control server 131. In addition, when the speech processing unit 362 receives a synthesis request, including text data, from the session control server 131, the speech processing unit 362 extracts the speech data corresponding to that text data from the speech information DB 361, and then sends this data to the session control server 131. In this way, the functions of this speech recognition/synthesis server 133 are realized using the speech recognition and speech synthesis technologies of the conventional art.

The portal server 111 includes a data request unit 331, a data receiving unit 332, a synthesizing unit 333, and an output processing unit 334. By executing programs (not shown in the drawings) loaded into the memory 202, the computing device 201 of the portal server 111 performs the functions of the data request unit 331, the data receiving unit 332, the synthesizing unit 333, and the output processing unit 334.

The data request unit 331 sends data requests to the session control server 131. The data receiving unit 332 receives data sent from the session control server 131. The synthesizing unit 333 synthesizes the received data to create data arranged in a single interface. The output processing unit 334 sends synthesized data to the user terminal 141 and user terminal 151, respectively.

The map information delivery server 121 includes a map information DB 341 and a request processing unit 342. The secondary storage device 206 of the map information delivery server 121 contains the map information DB 341. In addition, by executing programs (not shown in the drawings) loaded into the memory 202, the computing device 201 of the map information delivery server 121 performs the functions of the request processing unit 342.

The map information DB 341 stores map data. This map data is not particularly limited, and may for example include map image data, as well as address, place name, telephone number, latitude, and longitude for this map image data position. Upon receiving a data request from the session control server 131, the request processing unit 342 reads the requested map image data from the map information DB 341, and then sends this data to the session control server 131.

The schedule management server 122 includes a schedule information DB 351 and a request processing unit 352. The secondary storage device 206 of the schedule management server 122 contains the schedule information DB 351. In addition, by executing programs (not shown in the drawings) loaded into the memory 202, the computing device 201 of the schedule management server 122 performs the functions of the request processing unit 352.

The schedule information DB 351 stores schedule data for each user. This schedule data is not particularly limited and may for example include, for each user, date and time information, as well as the user's plans for those dates and times. This schedule data may for example store date and time information as well as user plans for those dates and times, the information corresponding to user accounts that have been issued to each user in advance. Upon receiving a data request from the session control server 131, the request processing unit 352 reads the requested schedule data from the schedule information DB 351, and then sends this data to the session control server 131.

The user terminal 141 and the user terminal 151 respectively include a telephony processing unit 371 and an output processing unit 372. By executing programs (not shown in the drawings) loaded into the memory 202, the respective computing devices 201 of the user terminal 141 and the user terminal 151 perform the functions of the telephony processing unit 371 and the output processing unit 372.

The telephony processing unit 371 responds to received calls and processes speech-based telephony by using the RTP and RTCP protocols of the conventional art. The output processing unit 372 has functions realized using a browser or a similar program, for example, and displays the portal site or other information sent from the portal server 111 on the display or another device of the output device 204.

Next, an example of the above-described information will be described.

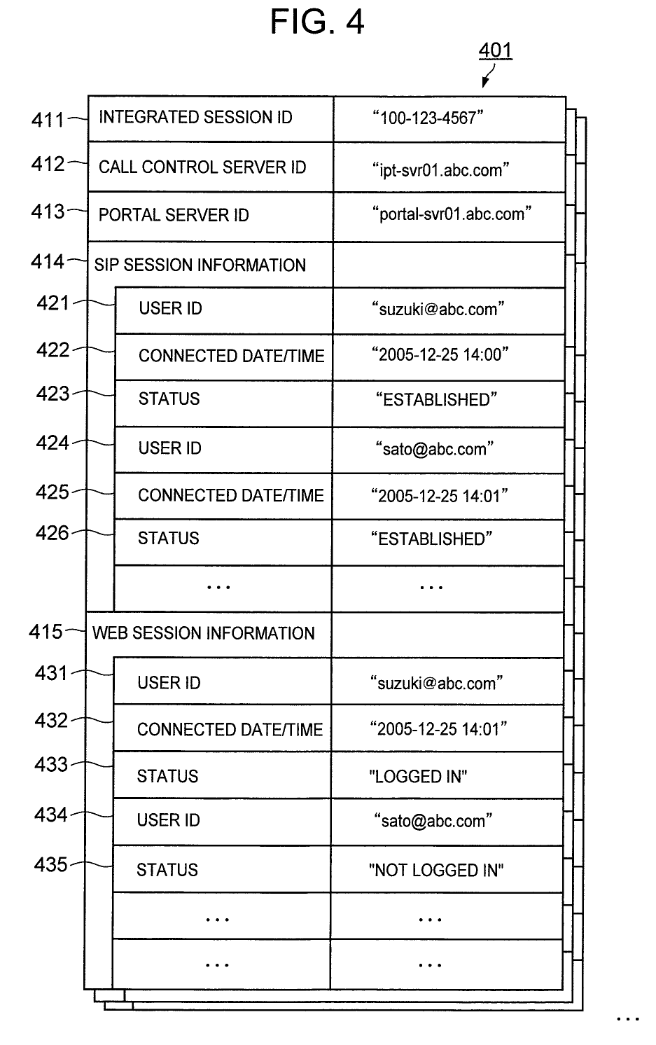

First, an example of the information in the session management DB 301 will be described with reference to FIG. 4.

In the present embodiment, the session information management unit 312 generates one table per session, and stores this table in the session management DB 301. In other words, in the case where a plurality of sessions have been established, a number of tables equal to the number of sessions are generated. Hereinafter, these tables will be referred to as session management tables.

As shown in FIG. 4, the session management table 401 includes an integrated session ID 411, a call control server ID 412, a portal server ID 413, SIP session information 414, and Web session information 415.

The integrated session ID 411 is information that identifies the session. The call control server ID 412 is information that identifies the call control server 132 that conducts call control. The portal server ID 413 is information that identifies the portal server 111 that provides portal services. In the present embodiment, the call control server ID 412 and the portal server ID 413 are the respective URLs (Uniform Resource Locators) of the call control server 132 and the portal server 111. The SIP session information 414 is information related to the session that establishes a call connecting with the session control server 131. The SIP session information 414 stores the session-related information for each device that establishes a session. More specifically, session information 414 may for example include a user ID 421, a connected date/time 422, status 423, a user ID 424, a connected date/time 425, status 426, and the like. The user ID 421 and the user ID 424 are identification information for the user A and the user B, respectively. The connected date/time 422 and the connected date/time 425 are dates/times that specify when a connecting was established between the session control server 131 and the user terminal 141 or the user terminal 151, respectively. The status 423 and the status 426 indicate whether or not a connecting was established between the session control server 131 and the user terminal 141 or the user terminal 151, respectively. The Web session information 415 is information related to the session that establishes a Web connecting to the portal server 111. In addition, the Web connecting herein refers to the user terminal 141 and the user terminal 151 respectively performing a login or similar operation on the portal server 111. The Web session information 415 stores session-related information for each device that establishes a session. More specifically, the Web session information 415 may for example include a user ID 431, a connected date/time 432, a status 433, a user ID 434, and a status 435, and the like. The user ID 431 and the user ID 434 are identification information for the user terminal 141 and the user terminal 151, respectively. The connected date/time 432 is date/time information specifying when a connecting between the user terminal 141 and the portal server 111 was established. The status 433 and the status 435 indicate whether or not a connecting was established between the portal server 111 and the user terminal 141 or the user terminal 151, respectively. In addition, in the example shown in FIG. 4, a connecting between the user terminal 151 and the portal server 111 has not yet been established. For this reason, a date/time specifying when a connecting was established between the user terminal 151 and the portal server 111 is not stored, and also the status 435 is “Not logged in.”

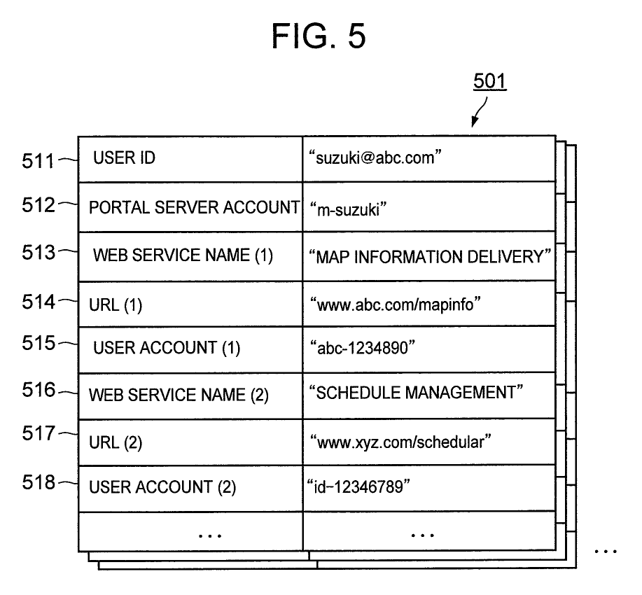

Next, an example of the information in the user management DB 302 will be described with reference to FIG. 5.

In the present embodiment, information related to a single user is managed using a single table, and this table is stored in the user management DB 302. In other words, in the case where a plurality of users use the system of the present embodiment, the user management DB 302 contains a number of tables equal to the number of these users. Hereinafter, these tables will be referred to as user management tables. These user management tables are stored in advance in the secondary storage device 206.

As shown in FIG. 5, a user management table 501 includes a user ID 511, a portal server account 512, a Web service name 513, a URL 514, a user account 515, a Web service name 516, a URL 517, and a user account 518.

The user ID 511 is information that identifies a user. The portal server account 512 is an account used when the user with the user ID 511 logs in or otherwise accesses the portal server 111. The Web service name 513 is the name of the service provided by the map information delivery server 121. The URL 514 is the URL for the map information delivery server 121. The user account 515 is an account used when the user with the user ID 511 logs in or otherwise accesses the map information delivery server 121. The Web service name 516 is the name of the service provided by the schedule management server 122. The URL 517 is the URL of the schedule management server 122. The user account 518 is an account used when the user with the user ID 511 logs in or otherwise accesses the schedule management server 122.

As described in the foregoing, in the present embodiment, the map information delivery server 121 and the schedule management server 122 provide data to a user. However, it should be appreciated that the servers that provide data to the user are not limited to the map information delivery server 121 and the schedule management server 122. In the case where servers and the like other than the above provide data to the user, the respective Web service names, URLs, user accounts of these other servers or similar data providers are further included in the user management table 501.

Next, exemplary operation will be described.

First, an exemplary sequence will be described herein, to be followed by a description of the exemplary operation of each device.

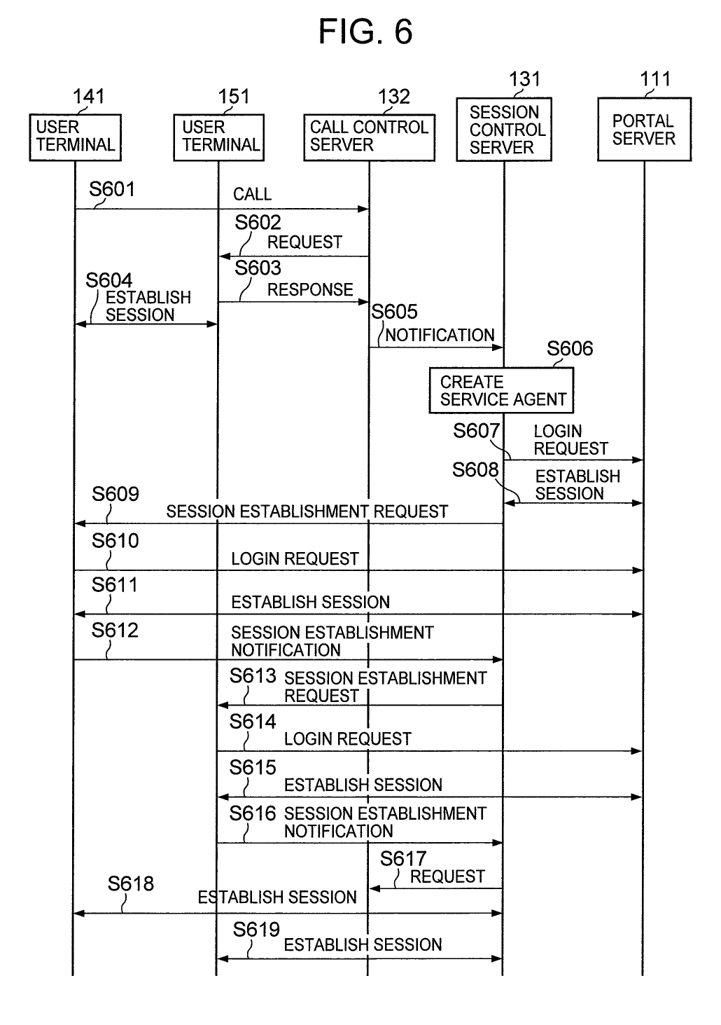

An exemplary sequence wherein a session is established will now be described with reference to FIG. 6. The example shown in FIG. 6 describes a case wherein data is sent from a user A to a user B.

Initially, both the telephony processing unit 371 of the user terminal 141 and the telephony processing unit 371 of the user terminal 151 respectively register their identification information and location information with the call control server 132 in advance, such as on startup (a REGISTER operation, and the like.). This is the same as the conventional art. Using the input device 205 of the user terminal 141, the user A specifies or otherwise indicates the identification information of the user B, issuing a call command. The telephony processing unit 371 of the user terminal 141 then begins call in accordance with this command (S601). The call control unit 321 of the call control server 132 then obtains the location of the user B's user terminal 151 from the registered location information, and sends a request with this location as the destination address (S602). When the user B answers or otherwise receives the call using the input device 205 of the user terminal 151, the telephony processing unit 371 of the user terminal 151 sends a response to the call control server 132 (S603). Upon receiving the response from the user terminal 151, the call control unit 321 of the call control server 132 forwards this response to the user terminal 141. The telephony processing unit 371 of the user terminal 141 then sends a response with respect to this response to the call control server 132. The call control unit 321 of the call control server 132 then forwards this response to the user terminal 151. In so doing, a session is established between the user terminal 141 and the user terminal 151 (S604). A session is established in this way uses conventional technology, such as SIP, for example. The sending and receiving of speech data between the user terminal 141 and the user terminal 151 after a session is established is conducted using conventional art, such as RTP, for example.

Meanwhile, when a session is established, the call control unit 321 of the call control server 132 sends to the session control server 131 session establishment information, which notifies the session control server 131 that a session was established (S605). This session establishment information includes the respective identification information of the user A and the user B whereby a session was established. The session information management unit 312 of the session control server 131 then creates a service agent 311 (S606). The portal server cooperating unit 314 of the session control server 131 sends a login request to the portal server 111 (S607). This login request contains the account of the session control server 131. The data request unit 331 of the portal server 111 then performs authentication by determining whether or not information matching the account contained in the login request is contained in a table or the like (not shown in the drawings) stored in advance in the secondary storage device 206 of the portal server 111. If login is permitted based on this authentication, the data request unit 331 sends a login permission acknowledgement to the session control server 131. In so doing, a Web session is established between the session control server 131 and the portal server 111 (S608).

Next, the service agent 311 of the session control server 131 sends a request to establish a Web session to the user terminal 141 (S609). The output processing unit 372 of the user terminal 141 sends a login request to the portal server 111 (S610). This login request contains the account or other information of the user terminal 141. The data request unit 331 of the portal server 111 then authenticates by determining whether or not information matching the account contained in the login request is contained in a table or the like (not shown in the drawings) stored in advance in the secondary storage device 206 of the portal server 111. If login is permitted based on this authentication, the data request unit 331 sends a login permission acknowledgement to the user terminal 141. In so doing, a Web session is established between the user terminal 141 and the portal server 111 (S611). Upon the establishment of a Web session, the output processing unit 372 of the user terminal 141 sends to the session control server 131 a Web session establishment notification, which notifies the session control server 131 that a Web session was established (S612).

In addition, the service agent 311 of the session control server 131 sends a request to establish a Web session to the user terminal 151 (S613). The output processing unit 372 of the user terminal 151 sends a login request to the portal server 111 (S614). This login request contains the account or other information of the user terminal 151. The data request unit 331 of the portal server 111 then authenticates by determining whether or not information matching the account contained in the login request is contained in a table, and the like. (not shown in the drawings) stored in advance in the secondary storage device 206 of the portal server 111. If login is permitted based on this authentication, the data request unit 331 sends a login permission acknowledgement to the user terminal 151. In so doing, a Web session is established between the user terminal 151 and the portal server 111 (S615). Upon the establishment of a Web session, the output processing unit 372 of the user terminal 151 sends to the session control server 131 a Web session establishment notification, which notifies the session control server 131 that a Web session was established (S616).

The call control server cooperating unit 313 of the session control server 131 sends to the call control server 132 a request to establish a SIP session, which contains the respective identification information for the user A and the user B (S617). The call control unit 321 of the call control server 132, by means of an operation similar to the above-described, respectively establishes sessions between the session control server 131 and the user terminal 141, as well as between the user terminal 151 and the session control server 131 (S618, S619).

In the foregoing exemplary sequence, an example was described wherein the session control server 131 sends a request to establish a SIP session subsequent to the establishment of a Web session. However, it should be appreciated that the timing of the transmission of the request to establish the Web session and the transmission of the request to establish the SIP session is not particularly limited. For example, in the foregoing process S601 to S616, commands for speech recognition and synthesis output may be issued using the input devices 205 of the user terminal 141 and the user terminal 151 while the user A and the user B are communicating via telephony or other means using the respective user terminal 141 and the user terminal 151, between which a session is established. In accordance with this command, the user terminal 141 and the user terminal 151 may then respectively send requests for speech recognition and synthesis output to the session control server 131. As another example, a table or other means (not shown in the drawings) indicating whether or not to conduct speech recognition and synthesis output for each user may be stored in advance in the secondary storage device 206 of the session control server 131. The call control server cooperating unit 313 may then refer to this table or the like, to determine whether or not the terminal that established a session in the foregoing process S601 to S616 will conduct speech recognition and synthesis output. Then, speech recognition and synthesis is conducted from step S617 onward. In addition, Web sessions may also be established after the SIP session is established.

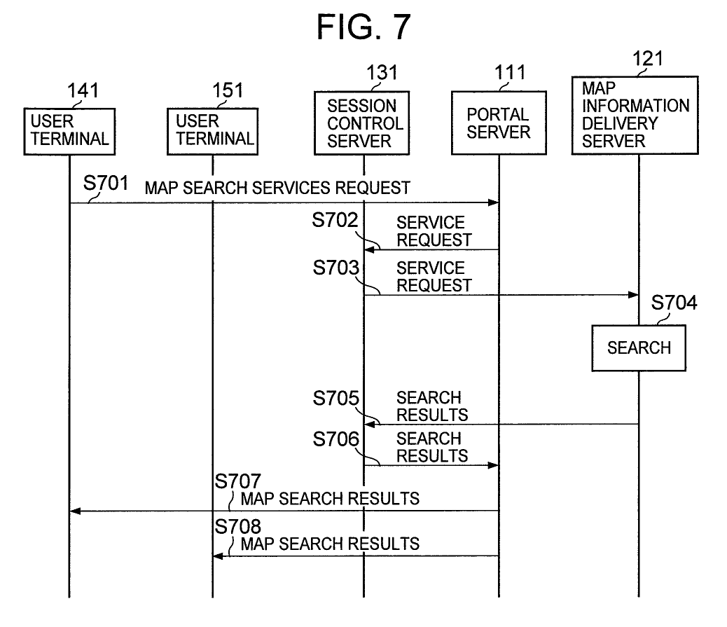

Next, an exemplary sequence wherein map data is obtained from the map information delivery server 121 will be described with reference to FIG. 7. The example herein will describe the case wherein the user A requests map search services. Moreover, this exemplary sequence describes the case wherein the obtained map data is input and output as image data. Since the exemplary sequence described using FIG. 7 is the same as the exemplary sequence shown in the foregoing FIG. 6 up to step S616 (i.e., up to the establishment of the SIP session and the Web sessions), the following will describe exemplary operation after that point.

Using the input device 205 of the user terminal 141 or other means, the user A issues a command to provide map search services. At this point, the user A issues the command along with map search conditions. The output processing unit 372 of the user terminal 141 sends to the portal server 111 a request for map search services that includes the map search conditions (S701). The data request unit 331 of the portal server 111 forwards this request for map search services to the session control server 131 (S702). The Web service cooperating unit 316 of the session control server 131 then sends to the map information delivery server 121 a request for map search services that includes the identification information for the user A (S703). After performing authentication using the identification information for the user A, the request processing unit 342 of the map information delivery server 121 searches the map information DB 341 in the secondary storage device 206 of the map information delivery server 121 for map data that matches the search conditions contained in the received request for map search services (S704). The request processing unit 342 then sends the map data or other information found by search to the session control server 131 (S705). The portal server cooperating unit 314 of the session control server 131 sends the received map data or other information to the portal server 111 (S706). The data receiving unit 332 of the portal server 111 receives the map data. The synthesizing unit 333 synthesizes or otherwise processes the received map data according to a pre-defined format, thereby generating output data. The output processing unit 334 then sends this generated output data to the user terminal 141 and the user terminal 151, respectively (S707, S708). The user terminal 141 and the user terminal 151 then respectively output the received output data to the output devices 204 thereof.

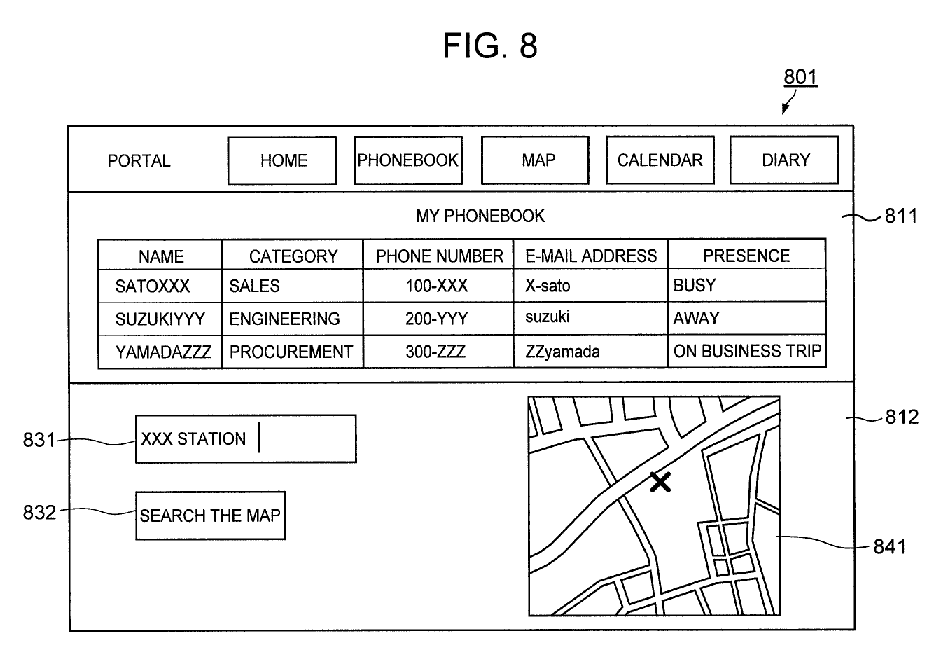

An exemplary screen layout will now be described with reference to FIG. 8 for the case when the user terminal 141 and the user terminal 151 respectively display output data on the output devices 204 thereof.

As shown in FIG. 8, a screen 801 has an area 811 and an area 812. The area 811 is an area displaying users for whom call is possible. The area 812 is an area for providing services. In the example of the screen 801, the area 812 is for providing search services on map data. The area 812 has an area 831 and an area 841. The area 831 is for receiving input search conditions for searching the map data. Search conditions are input into this area 831, and when a button 832 is pressed or otherwise operated, the respective output processing unit 372 of the user terminal 141 and the user terminal 151 send to the portal server 111 a request for map search services that includes the search conditions input into the area 831. In addition, the portal server 111 respectively sends to the user terminal 141 and the user terminal 151 the data that has been synthesized so as to display in the area 841 the map data found by search via the above-described exemplary operation. The respective output processing unit 372 of the user terminal 141 and the user terminal 151 then display the received data on the display or other means of the output device 204.

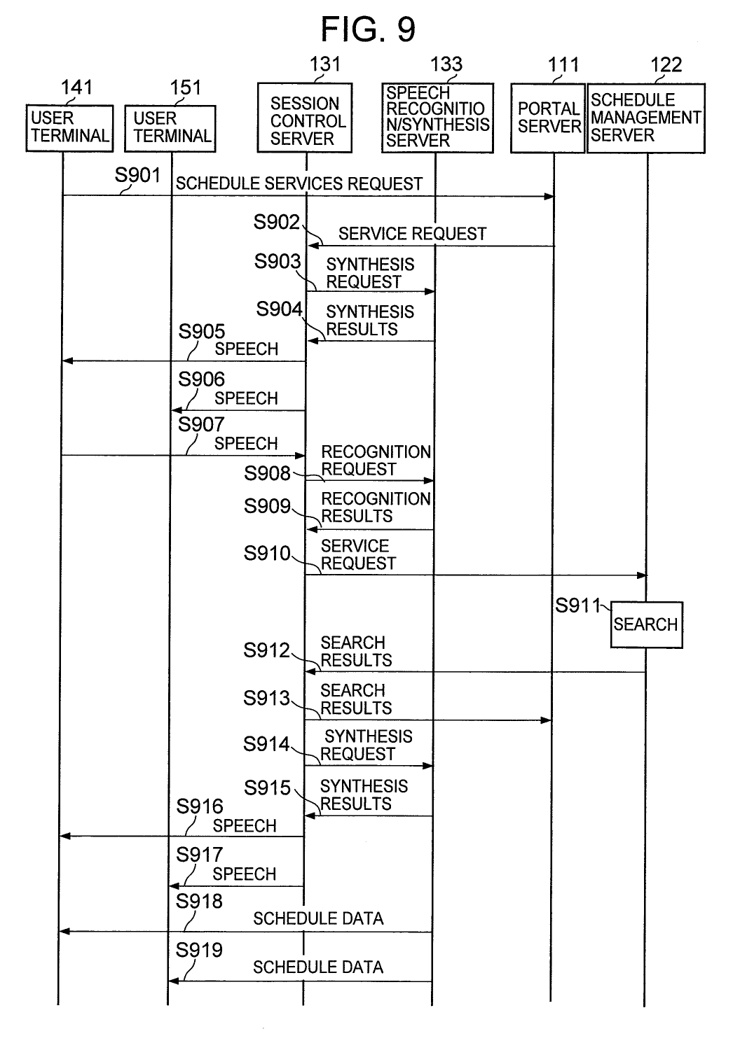

Next, an exemplary sequence wherein schedule data is obtained from the schedule management server 122 will be described with reference to FIG. 9. Moreover, this exemplary sequence describes the case wherein the search conditions for the requested schedule data are input as speech data, and wherein the obtained schedule data is output as speech data as well as image data. Since the exemplary sequence described using FIG. 9 is the same as the exemplary sequence shown in the foregoing FIG. 6 up to step S619 (i.e., up to the establishment of respective sessions with the user terminal 141 and the user terminal 151), the following will describe exemplary operation after that point.

The user A, using the input device 205 of the user terminal 141, presses or otherwise operates a button displayed on the display of the output device 204, thereby issuing a command to obtain schedule data. The output processing unit 372 of the user terminal 141 then sends to the portal server 111 a request for schedule services (S901). The data request unit 331 of the portal server 111 forwards this request for schedule services to the session control server 131 (S902).

In accordance with pre-defined VXML definitions, the speech recognition/synthesis service cooperating unit 315 of the session control server 131 sends to the schedule management server 122 a request for synthesis that includes text data (S903). The text data included in this request for synthesis is formatted for querying the conditions of the schedule data to be obtained, as defined by VXML definitions. The details of this text data will be described later.

The speech processing unit 362 of the schedule management server 122 extracts from the speech information DB 361 speech data corresponding to the text data including in the request for synthesis, and sends this speech data to the session control server 131 (S904). This process is the same as speech synthesis of the conventional art.

The telephony processing unit 317 of the session control server 131 then sends the speech data received from the schedule management server 122 to the user terminal 141 and the user terminal 151, respectively (S905, S906). The respective telephony processing unit 371 of the user terminal 141 and the user terminal 151 output this speech data from the speaker or other means of the output device 204.

The user A, using the microphone or other means of the input device 205 of the user terminal 141, inputs a response with respect to the speech data. The telephony processing unit 371 of the user terminal 141 then sends this speech data to the session control server 131 (S907).

The speech recognition/synthesis service cooperating unit 315 of the session control server 131 sends to the speech recognition/synthesis server 133 a request for recognition that includes the speech data input from the user terminal 141 (S908).

The speech processing unit 362 of the speech recognition/synthesis server 133 selects from the speech information DB 361 speech data that matches the received speech data, extracts the text data corresponding to the selected speech data, and then sends this text data to the session control server 131 (S909). This process is the same as the speech recognition of the conventional art.

Herein, the speech recognition/synthesis service cooperating unit 315 may also obtain other search conditions by repeating the above processes S903 to S909. For the sake of brevity, it will be assumed herein that all the necessary search conditions have been obtained.

The Web service cooperating unit 316 of the portal server 111 sends to the schedule management server 122 a request for services that includes the identification information for the user A and the user B, as well as the search conditions obtained in the above processes S903 to S909 (S910). The request processing unit 352 of the schedule management server 122 then searches the schedule information DB 351 in the secondary storage device 206 for schedule data that is corresponded to the identification information included in the request for services, and in addition, matches the search conditions included in the request for services (S911). The request processing unit 352 then sends the schedule data found by search to the session control server 131 (S912).

The portal server cooperating unit 314 of the session control server 131 sends to the portal server 111 a write request that includes the schedule data (S913) received for each user. The data receiving unit 332 of the portal server 111 receives this write request. The synthesizing unit 333 appends or otherwise adds the received schedule data in a predetermined format and creates screen data that displays the schedule data for each user.

Meanwhile, the speech recognition/synthesis service cooperating unit 315 of the session control server 131 sends to the speech recognition/synthesis server 133 a request for synthesis that includes text data (S914). The text data included in this request for synthesis is the schedule data for each user sent by the schedule management server 122 in the above process. The speech processing unit 362 of the speech recognition/synthesis server 133 then extracts from the speech information DB 361 the speech data corresponding to the text data included in the request for synthesis, and sends this speech data to the session control server 131 (S915). The telephony processing unit 317 of the session control server 131 then sends the speech data received from the schedule management server 122 to the user terminal 141 and the user terminal 151, respectively (S916, S917).

Meanwhile, the output processing unit 334 of the portal server 111 sends screen data displaying the per-user schedule data to the user terminal 141 and the user terminal 151, respectively (S918, S919). In so doing, the schedules for the user A and the user B are output as both speech and images from the respective output devices 204 of the user terminal 141 and the user terminal 151.

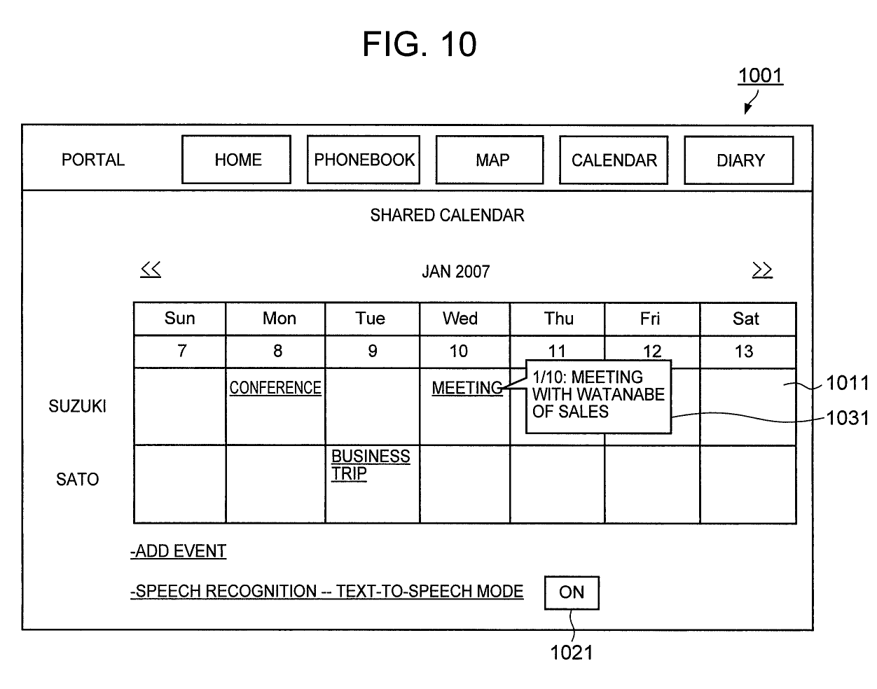

An exemplary screen layout for the case wherein schedule data is displayed on the respective displays of the output devices 204 of the user terminal 141 and the user terminal 151 will now be described with reference to FIG. 10.

As shown in FIG. 10, a screen 1001 has an area 1011. The area 1011 is an area for displaying a schedule for each user. Herein, it is possible for the user A and the user B to issue commands to conduct or not conduct speech recognition and synthesis output by pressing or otherwise operating a button 1021, using the respective input devices 205 of the user terminal 141 and the user terminal 151. In other words, each time the button 1021 is pressed or otherwise operated once, a request for speech recognition and synthesis output is sent alternately with a request to stop speech recognition and synthesis output, the requests being sent to the portal server 111 from the user terminal 141 and the user terminal 151, respectively. The data request unit 331 of the portal server 111 forwards the received request for speech recognition and synthesis output, and the request to stop speech recognition and synthesis output to the session control server 131. The session control server 131 then controls speech recognition and synthesis output in accordance with this request. In addition, when the user A and the user B respectively use the respective input devices 205 of the user terminal 141 and the user terminal 151 to specify or otherwise indicate any one of the schedules being displayed on the display of the respective output devices 204, that schedule's details are displayed, as shown by way of an example in the pop-up 1031 in FIG. 10.

Next, exemplary operation of the session control server 131 itself will be described.

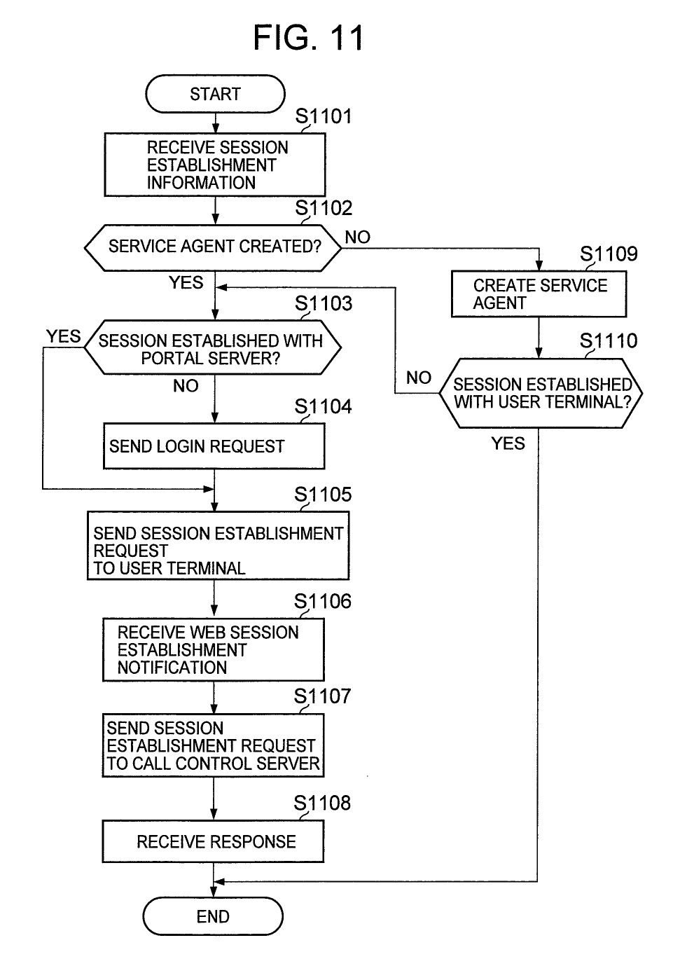

First, exemplary operation for the above steps S601 to S619, wherein sessions are established with the portal server 111, the speech recognition/synthesis server 133, the user terminal 141, and the user terminal 151, respectively, will be described with reference to FIG. 11.

The call control server cooperating unit 313 of the session control server 131 receives session establishment information from the call control server 132 (S101). As described above, this session establishment information includes the identification information for the user who established the session (user ID), as well as the identification information for the call control server 132 (call control server ID). The session information management unit 312 stores this session-related information in the session management DB 301. As a more specific example, the session information management unit 312 may first create a new session management table 401. Then, the session information management unit 312 obtains an integrated session ID for this session, and stores this ID as the integrated session ID 411 of the session management table 401. The technology whereby this integrated session ID is obtained is arbitrary, and may for example comprise combining a predetermined value with a serial number. Furthermore, the session information management unit 312 stores the identification information of the call control server 132 included in the session establishment information as the value of the call control server ID 412 of the session management table 401.

Next, the session information management unit 312 determines whether or not a service agent 311 has been created (S1102). This determination is arbitrary, and may for example comprise referencing a flag that indicates whether or not a service agent 311 has been created.

If the result of the determination in step S1102 is such that a service agent 311 has been created, the service agent 311 determines whether or not the session control server 131 has established a session with the portal server 111 (S1103). This determination is arbitrary, and may for example comprise referencing a flag that indicates whether or not a session has been established.

If the result of the determination in step S1103 is such that a session has not been established, the portal server cooperating unit 314 sends a login request to the portal server 111 (S1104). This login request includes the account of the session control server 131. As described above, the data request unit 331 of the portal server 111 first authenticates the login request, and then sends a response. This response includes the identification information of the portal server 111. Upon receiving a response from the portal server 111, the session information management unit 312 of the session control server 131 updates the session management table 401 that is newly-generated in the above process. More specifically, the session information management unit 312 stores the received identification information of the portal server 111 that was included in the response to the login request as the value of the portal server ID 413 in the newly-generated session management table 401.

On the other hand, if the result of the determination in the above step S1103 is such that a session has been established or after the process in step S1104, the service agent 311 sends a request to establish a Web session to the user terminals (S1105). In order to do so, the service agent 311 sends a request to establish a Web session wherein the destination addresses are set to be the respective identification information for the users (user IDs) that were included in the session establishment information sent by the call control server 132. As a more specific example, the service agent 311 sends a request to establish a Web session to the user terminal 141 and the user terminal 151, respectively. In addition, the session information management unit 312 updates the session management table 401 that is newly-generated in the above process. More specifically, the session information management unit 312 takes the received user identification information that was included in the session establishment information received in the above step S1101, and then stores this user identification information in the Web session information 415 of the session management table 401 that is newly-generated in the above process. Furthermore, for each of these sets of user identification information, the session information management unit 312 stores information that indicates the status of that user as being “not logged in.”

Having received respective requests to establish a Web session, the user terminal 141 and the user terminal 151 send to the portal server 111 login requests that include the identification information, or the like, of the user terminal 141 and the user terminal 151, respectively. The portal server 111 authenticates the requests by determining whether or not information that matches the identification information included in the login requests is included in a table stored in the secondary storage device 206 of the portal server 111. The portal server 111 then sends the authentication result to the user terminal 141 and the user terminal 151, respectively. If authenticated, the user terminal 141 and the user terminal 151 respectively send to the session control server 131 Web session establishment notifications, which notify the session control server 131 that the respective users have logged in.

The service agent 311 receives the Web session establishment notification sent by a user terminal (S1106). The session information management unit 312 then updates the session management table 401 that is newly-generated in the above process. More specifically, for each Web session establishment notification that is received, the session information management unit 312 updates the status of the corresponding user to “logged in”, this status being stored for each set of user identification information in the Web session information 415 of the session management table 401 that is newly generated in the above process. Furthermore, the session information management unit 312 stores the date/time when a Web session establishment notification was received as the connected date/time with respect to the user terminal that sent the Web session establishment notification. This date/time information is stored among the user identification information of the Web session information 415.

Next, the call control server cooperating unit 313 sends a request to establish a session to the call control server 132 (S1107). This request to establish a session includes the user identification information that was included in the session establishment information received in the above step S1101. In addition, the session information management unit 312 updates the session management table 401 that is newly-generated in the above process. More specifically, the session information management unit 312 takes the user identification information included in the session establishment information that was received in the above step S1101, and stores this user identification information in the SIP session information 414 of the session management table 401 that is newly generated in the above process. Furthermore, for each of these sets of user identification information, the session information management unit 312 stores information that indicates the status of that user's session as being “not established.”

Next, in a manner similar to the above, the call control unit 321 of the call control server 132 obtains the location information of the user terminal 141 and the user terminal 151 from this user identification information. By then sending requests with this location information set as the destination addresses, the call control unit 321 of the call control server 132 establishes respective SIP sessions between the session control server 131 and the user terminal 141, as well as between the session control server 131 and the user terminal 151. The call control unit 321 of the call control server 132 sends the session establishment process results to the session control server 131. The call control server cooperating unit 313 of the session control server 131 receives the session establishment process results (S1108). The session information management unit 312 stores the session establishment process results in the session management DB 301. More specifically, the session information management unit 312 stores the received session establishment process results as the status for each set of user identification information in the SIP session information 414 of the session management table 401 that is newly generated in the above process. In the case where the session establishment process results notify the session information management unit 312 that a session has been established, the session information management unit 312 furthermore stores the date/time when a session establishment process result was received as the connected date/time in the corresponding set of user identification information.

On the other hand, if the result of the determination in the above step S1102 is such that a service agent 311 has not been created, the session information management unit 312 creates a service agent 311 (S1109). This process may for example comprise the session information management unit 312 executing a predetermined module program.

The service agent 311 determines whether or not a SIP session has been established between the session control server 131 and the user terminal corresponding to the identification information included in the session establishment information that was received in the above step S1101 (S1110). This determination is arbitrary, and may for example comprise determining whether or not information that matches the identification information included in the session establishment information that was received in the above step S1101 is included in the SIP session information 414 of the session management table 401 in the session management DB 301.

If the result of the determination in step S1110 is such that a SIP session has not been established, the process starting from the above step S1103 is conducted.

It should be appreciated that, as stated above, the timing of the establishment of the SIP session is arbitrary.

If the result of the determination in step S1110 is such that a SIP session has been established, the process ends.

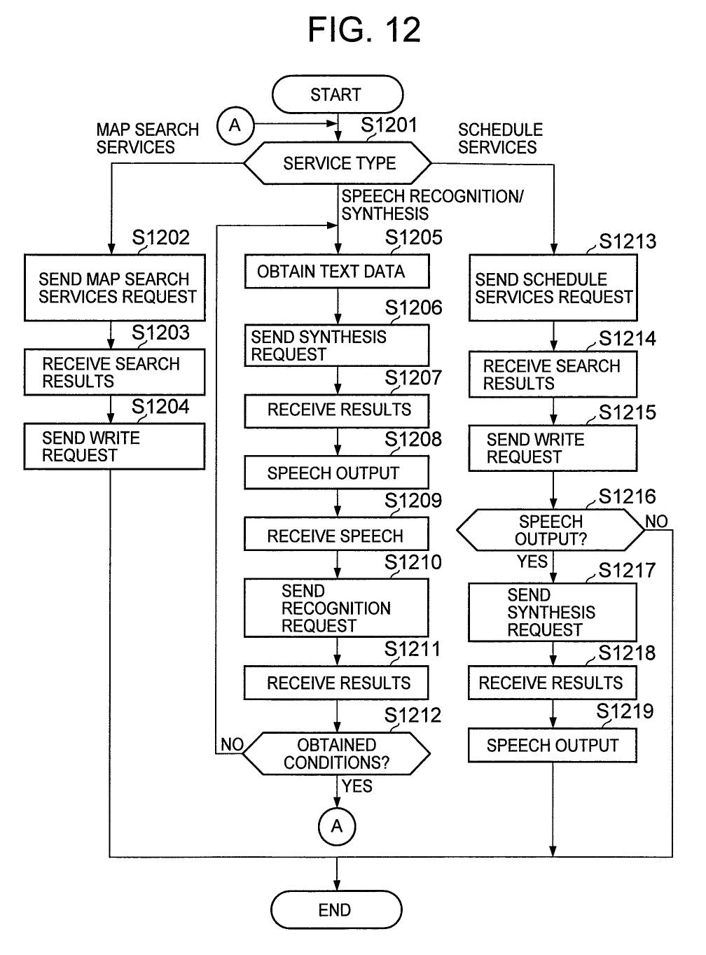

Next, exemplary operation for the above steps S701 to S708 and S901 to S919, wherein the session control server 131 provides data to user terminals, will be described with reference to FIG. 12.

As described above, the user terminal 141 and the user terminal 151 respectively send requests that include their respective identification information (user ID). The data request unit 331 of the portal server 111 forwards the received requests to the session control server 131.

The portal server cooperating unit 314 of the session control server 131 receives the requests forwarded from the portal server 111. Upon receiving these requests, exemplary operation as shown in FIG. 12 is initiated.

The service agent 311 determines the type of requested service from the request that is input from the portal server 111, the service types being map search services, speech recognition and synthesis services, and schedule services (S1201). This determination may for example comprise the service agent 311 determining that the request is for map search services in the case where information indicating a map services request is included in the input request. As another example, if the input request includes information that indicates a schedule services request, the service agent 311 determines that the request is for schedule services. In this case, the service agent 311 issues a command to the Web service cooperating unit 316 corresponding to a map search services request or a schedule services request.

As an another example, if the input request includes information that indicates either a map search services request or information that indicates a schedule services request, and in addition includes a command for speech recognition and synthesis services, the service agent 311 determines that speech recognition and synthesis services are to be conducted. It should be appreciated that the process whereby it is determined that a command for speech recognition and synthesis has been issued is arbitrary. For example, the determination may comprise referencing a table or other data that indicates, on a per-user basis, whether or not speech recognition and synthesis output is to be conducted. Alternatively, it may be determined whether or not the input request includes information that requests these services. In this case, the service agent 311 issues a corresponding command for speech recognition and synthesis services to the speech recognition/synthesis service cooperating unit 315.

If the result of the determination in step S1201 is such that map search services are requested, the Web service cooperating unit 316 sends a search request to the map information delivery server 121 (S1202). The Web service cooperating unit 316 sends this search request including search conditions such as a place name or address, as well as the account or other information for the user A or the user B. These search conditions may be information that was included in the request for map search services sent by the user terminal 141 and the user terminal 151, respectively. Alternatively, these search conditions may be information obtained by speech synthesis and speech recognition processing, to be described later. Also, in order to obtain the account of the user A or the user B, the service agent 311 may for example select information having a user ID 511 that matches the user identification information included in the request forwarded from the portal server 111, this information being selected from among the user management tables 501 in the user management DB 302. The service agent 311 then extracts the user account 515 for the Web service name 513 “Map Information Delivery” from the selected user management table 501.

Upon receiving a search request, the request processing unit 342 of the map information delivery server 121 conducts authentication using the account included in the search request. This authentication may for example comprise the request processing unit 342 determining whether or not information that matches the account included in the search request is included in a table (not shown in the drawings) stored in advance in the secondary storage device 206 of the map information delivery server 121. Next, the request processing unit 342 reads out from the map information DB 341 the map data satisfying the search conditions included in the search request, and then sends this map data to the session control server 131. As a more specific example, the request processing unit 342 reads from the map information DB 341 a predetermined area of map image data that includes the location specified by search conditions such as a place name or address. The request processing unit 342 then sends this predetermined area of map image data to the session control server 131.

The Web service cooperating unit 316 of the session control server 131 receives the map image data sent by the map information delivery server 121 (S1203). The portal server cooperating unit 314 then sends to the portal server 111 a write request that includes this map image data (S1204). The data receiving unit 332 of the portal server 111 receives the write request. The synthesizing unit 333 combines or otherwise processes the map image data that was included in the received write request according to a predetermined format or other rules, thereby generating output data. The output processing unit 334 of the portal server 111 then sends the output data generated by the synthesizing unit 333 to the user terminal 141 and the user terminal 151. It should be appreciated that the transmission destinations for the output data may be obtained from information managed by the portal server 111 for each session. Alternatively, the transmission destinations may be obtained from information included in the write request, the information being obtained user IDs, and the like, extracted by the session control server 131 from the Web session information 415 of the session management table 401.

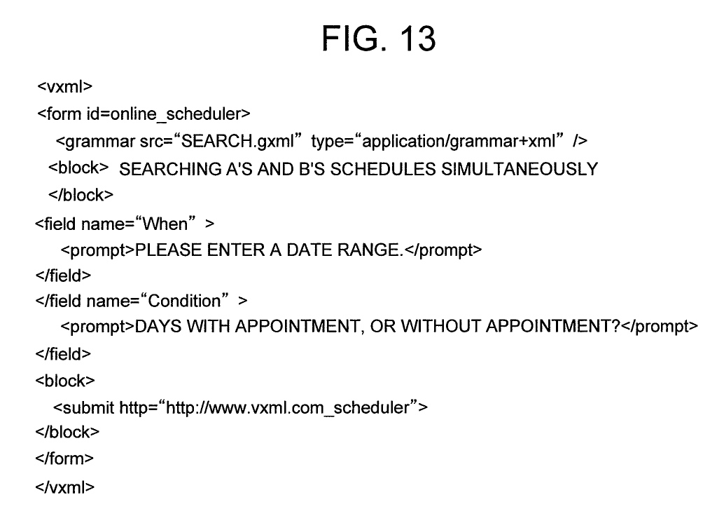

On the other hand, if the result of the determination in step S1201 is such that speech recognition and synthesis services are requested, the speech recognition/synthesis service cooperating unit 315 obtains text data for querying the conditions of the data to be obtained, in accordance with pre-defined VXML definitions (S1205). An exemplary VXML definition of the present embodiment is shown in FIG. 13. The example in FIG. 13 is an example of VXML when receiving schedule services. The VXML definitions are arbitrary, and as shown by way of the example in FIG. 13, a plurality of search conditions may be obtained over several queries.

Next, the speech recognition/synthesis service cooperating unit 315 sends to the schedule management server 122 a request for synthesis that includes the text data acquired in the above step S2105 (S1206). The text data included in this request for synthesis is data for querying the conditions of the schedule data to be obtained, as defined by VXML definitions.

As described above, the speech processing unit 362 of the schedule management server 122 extracts from the speech information DB 361 speech data corresponding to the text data included in the request for synthesis, and then sends this speech data to the session control server 131.

The speech recognition/synthesis service cooperating unit 315 of the session control server 131 receives the speech data sent by the schedule management server 122 (S1207). The telephony processing unit 317 of the session control server 131 then sends this speech data to the user terminal 141 and the user terminal 151, respectively (S1208).

The respective telephony processing unit 371 of the user terminal 141 and the user terminal 151 output this speech data from the speaker or other means of the output device 204. Using the microphone or other means of the input device 205 of the user terminal 141 or the user terminal 151, one of either the user A or the user B inputs a response to the speech data. Herein, it is assumed that the user A inputs speech data using the input device 205 of the user terminal 141. The telephony processing unit 371 of the user terminal 141 then sends this speech data to the session control server 131. This process is the same as the telephony process of the conventional art.

The telephony processing unit 317 of the session control server 131 receives the speech data (S1209). The speech recognition/synthesis service cooperating unit 315 then sends to the speech recognition/synthesis server 133 a recognition request that includes the speech data received in step S1209 (S1210).

The speech processing unit 362 of the speech recognition/synthesis server 133 selects speech data from the speech information DB 361 that matches the received speech data, extracts the text data corresponding to the selected speech data, and then sends to the session control server 131 a response that includes this text data.

The speech recognition/synthesis service cooperating unit 315 of the session control server 131 receives the response from the speech recognition/synthesis server 133 that includes the text data (S1211). Next, the speech recognition/synthesis service cooperating unit 315 determines whether or not all the search conditions have been obtained (S1212). This determination may for example comprise determining whether or not a pre-defined process has been conducted, as defined by VXML definitions.

If the result of the determination of step S1212 is such that the search conditions have not been obtained, the speech recognition/synthesis service cooperating unit 315 again conducts the process starting from the above step S1205.

If the result of the determination of step S1212 is such that the search conditions have been obtained, the speech recognition/synthesis service cooperating unit 315 again conducts the process starting from the above step S1201. In other words, if an input request includes information that indicates a map search services request, the process starting from the above step S1202 is conducted. Alternatively, if an input request includes information that indicates a schedule services request, the process starting from step S1213, to be described later, is conducted.

If the result of the determination in step S1201 is such that the received request is a request for schedule services, the Web service cooperating unit 316 of the session control server 131 sends a service request to the schedule management server 122 (S1213). This service request may include search conditions for searching a schedule, such as user identification information, account information, date/time information, and time period information, for example. The identification information included in the service request sent to the schedule management server 122 includes the received request for schedule services. In other words, in accordance with user commands, the user terminal 141 and the user terminal 151 respectively send a request for schedule services that includes the identification information of the user requesting a schedule. In addition, the identification information included in the service request sent to the schedule management server 122 is the information obtained by the session control server 131. In order to obtain this account information, the service agent 311 may for example select information having a user ID 511 that matches the user identification information included in the request forwarded from the portal server 111, this information being selected from among the user management tables 501 in the user management DB 302. The service agent 311 then extracts the user account 518 for the Web service name 516 “Schedule management” from among the selected user management table 501. It should be appreciated that the accounts obtained herein may be those of all or a portion of the users engaged in telephony. In addition, the search conditions included in the service request sent to the schedule management server 122 may also be included in the request for schedule services sent from the user terminal 141 and the user terminal 151, respectively. Alternatively, the search conditions may be obtained using the above-described speech synthesis and recognition process.

Upon receiving the search request, the request processing unit 352 of the schedule management server 122 conducts authentication using the account included in the search request. This authentication may for example comprise the request processing unit 352 determining whether or not information that matches the account included in the search request is included in a table (not shown in the drawings) stored in advance in the secondary storage device 206 of the schedule management server 122. Next, the request processing unit 352 reads out from the schedule information DB 351 the schedule data that satisfies the search conditions included in the received request for schedule services. As a more specific example, if the search conditions include respective identification information for the user A and the user B as well as time period information, then the request processing unit 352 reads from the schedule information DB 351 the schedule data that corresponds to the dates/times inclusive to the time periods in the search conditions, this process being conducted for the respective identification information of the user A and the user B. The request processing unit 352 then sends to the session control server 131 a response that includes the schedule data that was read for each user.

The Web service cooperating unit 316 of the session control server 131 receives the sent response (S1214). The call control server cooperating unit 313 then sends to the portal server 111 a write request that includes the schedule data for each user and other information included in this response (S1215).

The data receiving unit 332 of the portal server 111 receives the write request. The synthesizing unit 333 combines or otherwise processes the schedule data for each user, included in the received write request according to a predetermined format or other rules, to generate output data. The output processing unit 334 of the portal server 111 then sends the output data generated by the synthesizing unit 333 to the user terminal 141 and the user terminal 151. It should be appreciated that the transmission destinations for the output data may be obtained from information managed by the portal server 111 for each session. Alternatively, the transmission destinations may be obtained from information included in the write request, the information being user IDs, extracted by the session control server 131 from the Web session information 415 of the session management table 401.

Meanwhile, the service agent 311 of the session control server 131 determines whether or not a command for speech output has been issued (S1216). This process is arbitrary, and may for example be determined by referencing a table or other information that indicates, on a per-user basis, whether or not speech recognition and synthesis output is to be conducted. Alternatively, it may be determined whether or not the input request includes information requesting these services.

If the result of the determination in step S1216 is such that a command for speech output has not been issued, the process ends.

If the result of the determination in step S1216 is such that a command for speech output has been issued, the speech recognition/synthesis service cooperating unit 315 sends to the speech recognition/synthesis server 133 a request for synthesis that includes the schedule data received in the processing of the above step S1214 (S1217).

The speech processing unit 362 of the schedule management server 122 extracts from the speech information DB 361 speech data corresponding to the text data included in the request for synthesis, and then sends to the session control server 131 a response that includes this speech data.

The speech recognition/synthesis service cooperating unit 315 of the session control server 131 receives the response sent by the schedule management server 122 (S1218). The telephony processing unit 317 of the session control server 131 then sends this speech data to the user terminal 141 and the user terminal 151, respectively (S1219).

As a result of the above-described process, it becomes possible to respectively provide identical information to a plurality of user terminals. In so doing, it becomes possible for a user to engage in telephony with another party while both are referring to the same information. Moreover, it becomes possible to convert information to speech data and provide this speech data to the users.

### Second Embodiment

Next, a second embodiment will be described.

The second embodiment to be described below differs from the foregoing first embodiment in that the devices used by the users are mobile phones. Since exemplary configurations and exemplary operation are otherwise the same as the foregoing first embodiment, system configuration that is different will be described.

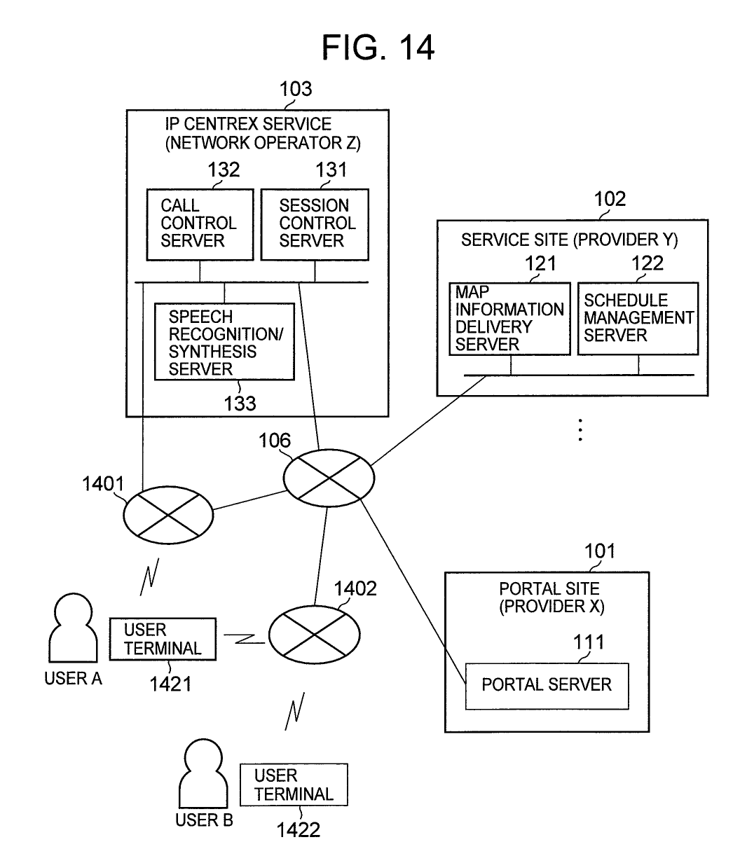

FIG. 14 shows an exemplary system configuration of the second embodiment. As shown in FIG. 14, the communications network 106 is further connected to a mobile network operator network 1401 and a public wireless LAN network 1402. A user terminal 1421 and a user terminal 1422 are respectively mobile phones. The user terminal 1421 and the user terminal 1422 are respectively connected to the mobile network operator network 1401 and the public wireless LAN network 1402, respectively, and also connected to the communications network 106 via either of the above.

The functions and exemplary operation of the respective user terminal 1421 and user terminal 1422 are the same as those of the foregoing user terminal 141 and the user terminal 151 of the first embodiment, and thus their description will be omitted.

In this way, by applying the present embodiment to mobile phones, it becomes possible for users to view a map and confirm schedules while engaged in telephony.

While the embodiments of the present invention have now been described in detail with reference to the accompanying drawings, it should be appreciated that specific configurations are not limited to the above embodiments, and design modifications may be made within the scope of the invention without departing from the spirit thereof.

As a more specific example, although in the foregoing embodiments an exemplary case was described wherein map and schedule information is provided to users, the data to be provided is arbitrary and not necessarily limited to the above. For example, it is possible to provide data such as e-mail, files for arbitrary application software, dynamic image data, still image data, speech data, or text data.

In addition, although in the foregoing embodiments an exemplary case was described wherein schedule search conditions are obtained using speech synthesis and recognition, the invention is not necessarily limited thereto. Schedule search conditions may also be input by the user as text data, using means such as a keyboard, switches, or buttons. Conversely, map search conditions may also be obtained using speech synthesis and recognition.

In addition, although in the foregoing embodiments a portal server sends to user terminals output data that includes requested data, the invention is not necessarily limited thereto. The session control server may also send output data to the user terminals. In other words, the source that sends the output data to user terminals is arbitrary.

In addition, although in the foregoing embodiments a speech recognition/synthesis server conducts speech recognition and synthesis processing, the invention is not necessarily limited thereto. The session control server may also conduct speech recognition and synthesis processing. In other words, the device that conducts speech recognition and synthesis processing is arbitrary.

The specification and drawings are, accordingly, to be regarded in an illustrative rather than a restrictive sense. It will, however, be evident that various modifications and changes may be made thereto without departing from the spirit and scope of the invention as set forth in the claims.

We claim:

1. A control device connected to each of a plurality of user terminals and a plurality of information providing devices that provide requested information, the control device comprising:
a request receiving unit which receives a data request from any one of the user terminals while an user terminals establish a session and communication is being conducted thereby;
a requesting unit which sends the data request to any one of the information providing devices; and
a providing unit which provides information sent by the information providing device to each of the user terminals, in a state in which the session is maintained and with a suitable data format.

2. The control device according to claim 1, further comprising:
a conversion unit which converts the information sent by the information providing device into a different format;
wherein the providing unit provides the information in the converted format to each of the user terminals.

3. A control device connected to user terminals respectively having an input-output device and mutually inputting and outputting speech, as well as to an information providing device that provides requested information, the control device comprising:
a request receiving unit which receives a data request from any one of the user terminals while an user session is established;
a requesting unit which sends the data request to the information providing device; and
a providing unit which provides information sent by the information providing device to each of the user terminals.

4. The control device according to claim 3, further comprising:
a conversion unit for converting text data included in the information sent by the information providing device, into speech data;
wherein the providing unit provides the speech data to each of the user terminals.

5. The control device according to claim 3, wherein:
the providing unit provides image data included in the information sent by the information providing device, to each of the user terminals.

6. A method for providing information in a system wherein user terminals respectively having input-output devices and mutually inputting and outputting speech, as well as an information providing device that provides requested information, are connected to a control device, the control device performing the steps of:
receiving a data request from any one of the user terminals while the user terminals establish a session;
sending the data request to the information providing device; and
providing information sent by the information providing device to each of the user terminals.

7. A program for providing information in a system wherein user terminals respectively having input-output devices and mutually inputting and outputting speech, as well as an information providing device that provides requested information, are connected to a control device, the program executing, on the control device, the steps of:
receiving a data request from any one of the user terminals while user terminals establish a session;
sending the data request to the information providing device; and
providing information sent by the information providing device to each of the user terminals.
